(19) United States
(12) Patent Application Publication
(10) Pub. No.: US 2002/0168089 A1
(43) Pub. Date: Nov. 14, 2002

(54) Method and apparatus for providing authentication of a rendered realization

(75) Inventors: Carsten Guenther, Bammental (DE); Werner Kriechbaum, Ammerbuch-Breitenholz (DE); Siegfried Kunzmann, Heidelberg (DE); Bernhard Hubert Zeller, Heidelberg (DE)

Correspondence Address: Marilyn Smith Dawkins, International Business Machines Corporation, Intellectual Property Law Department, 11400 Burnet Road, Internal Zip 4054, Austin, TX, 78758, US

(73) Assignee: International Business Machines Corporation, Armonk, NY (US)

(21) Appl. No.: 10/142,609

(22) Filed: May 9, 2002

(30) Foreign Application Priority Data
May 12, 2001 (DE) 01111630.8

(51) Int. Cl. G06K 9/00

(52) U.S. Cl. 382/100

(57) ABSTRACT

Disclosed are a method, apparatus, and program for providing authentication of a rendered multimedia realization. A renderer and a watermark generator are integrated wherein the renderer receives a symbolic stream, e.g. in the case of a text-to-speech system a text, and generates a realization, e.g. an audio signal representing a spoken version of the text. An identification is embedded into the signal by the watermark generator using standard steganographic methods. Such a serial integration of renderer and watermark generator is applicable to all known renderers and watermarking techniques. The mechanism enables inheritance of originality of the original representation or realization to the rendered realization.

### BACKGROUND OF THE INVENTION

The invention generally relates to a method and apparatus for rendering a digital representation into a digital realization.

Modern data compression techniques increasingly rely on the transmission of a symbolic representation of the data instead of a rendered realization. An example for this approach is the use of text-to-speech systems (TTS) to produce and transmit speech data. In this case not an audio stream but just the text is transmitted and the audio stream is rendered by speech synthesis when needed.

An additional example is provided by the symbolic encoding of music with techniques like the one used by the MPEG--4 synthetic audio standard. Here not only a score but, in addition, the instrument characteristics and details of interpretation are encoded and any standard compliant renderer will realize such a score in the same way. Such techniques are by no means restricted to audio data: The virtual reality modeling language (VRML) uses similar methods to describe visual scenes.

As a further example, it is referred to technical drawings prepared by utilizing a computer aided design (CAD) system where it is possible to transmit only vectorized data representing the drawing and to “render”, i.e. to visualize the drawing, on side of the receiver of the transmitted data using a graphical engine or using a printer or plotter in case of an appropriate data format.

It should be noted that the term “renderer”, in the present context, is understood to include all software or hardware devices which allow to render a representation into a realization like the devices described hereinbefore and hereinafter.

Although rather powerful in a technical view, the above approach poses some problems. The realization produced by rendering the symbolic representation may be distributed as a genuine realization by anyone having access to a renderer. Beyond that, it is possible to model the characteristics of a specific instrument and/or a specific player and thus to produce from a score of a classical music piece a new realization by another famous musician which has never been recorded in reality, thus considerably challenging the meaning of originality or a rendered multimedia realization.

Whereas the distribution of such a recording is “only” a new type of copyright infringement, applying the same techniques to TTS systems raises severe security issues. Even with today's technology, any TTS system can take on the identity of another TTS system and thus lure a customer into a business transaction with an impostor. Within the next few years TTS systems will be able to mimic the characteristics of a specific human speaker and leave anyone in doubt whether a message on a phone box originated from a human or was faked by a machine.

All the above approaches thus have in common the drawback that they do not provide a mechanism for authentication of an original realization, e.g. an original speaker whose voice is used in a TTS environment or an originally recorded piece of music used in an MPEG compression technique environment. These approaches also neither provide a mechanism for testing originality of the originator of a rendered multimedia realization nor such a test for determining originality of a used renderer itself.

### SUMMARY OF THE INVENTION

It is therefore an object of the present invention to provide a method and apparatus to provide a mechanism for authentication of a rendered multimedia realization.

Another object is to provide a mechanism to determine originality of a renderer used for rendering a multimedia realization.

It is yet another object to provide transmission of trusted speech signals or other trusted work products like CAM or CAD plans.

The above objects are attained by the features of the claims.

The invention is to integrate a renderer and a watermark generator. The renderer receives a symbolic stream, e.g. in the case of a TTS system a text, and generates a realization, e.g. an audio signal representing a spoken version of the text. Into this signal, an identification is embedded by the watermark generator using standard steganographic methods. Such an integration of a renderer and a watermark generator is applicable to all known renderers and all known watermarking techniques.

A mechanism is provided which enables identification of originality of a rendered realization, or provides a renderer which is able to identify itself.

In more detail, the invention applies steganographic techniques to renderers producing a realization from a symbolic representation and allows to embed a signature or watermark in the generated signal that identifies the individual renderer used, or the source of the rendered data, or both.

In a first embodiment, the watermark generator is used to embed a signature identifying the renderer in the generated signal. In the case of a hardware based renderer this signature can be given by the type code and the serial number of the renderer stored in read only registers in the renderer's hardware. In the case of a software based renderer this signature can be given by the name of the executable and its serial number. It should be noted that in both cases the identification can be stored in encrypted form to prevent the unauthorized takeover of a renderer's identity by an impostor.

According to a second embodiment, the watermark generator is used to embed a signature in the generated signal that characterizes the symbolic representation used to render the realization. Typical examples for such signatures are the file name of the symbolic representation, a copyright notice identifying the copyright holder of the symbolic representation, or the identity of the institution that used the renderer to generate the signal. But this signature may as well be a copy of a watermark that has been applied to the representation with methods as described in International Patent Application WO 00/45545.

In a third embodiment, a mechanism is provided for the identification of a speech signal generated by a TTS system that uses speech samples to generate a realization from the input of textual information.

The invention thereupon allows to provide trusted speech signals generated by a TTS system or trusted digital voice connections via computer or telephone where the recipient of a synthesized message can take a conservative approach and accept only those messages as genuine that can identify their origin by a known signature. As a result, web offerings via speech can be made highly secure. In addition, the invention allows for an identification of parts that are manufactured by rendering construction plans or the like. It should be mentioned that construction plans include but are not limited to CAD or CAM generated building plans or integrated circuit layouts like application-specific integrated circuits (ASICs).

Further it should be noted that the term “renderer” again is understood herein in its broadest sense including but not limited to the above TTS systems, multimedia data compression and decompression engines like MPEG-2 or -4, software or hardware CD- or DVD players, to MIDI or other music formats compatible synthesizers, CAD or CAM systems or even high- or low-level programming language compilers.

Further it should be noted that the term “realization” too is understood herein in its broadest sense, including but not limited to realizations that are directly accessible to a human observer like e.g. a generated audio signal. It equally well applies to encoded representations like e.g. MPEG-1 or MPEG-2 streams that need further processing to become accessible for a human observer.

### BRIEF DESCRIPTION OF THE DRAWINGS

In the following, the invention will be described in more detail by way of embodiments from which further features and advantages of the invention become evident.

FIG. 1 shows the basic principles of first embodiment of the invention where watermarking is used for rendering a representation;

FIG. 2 shows a first embodiment of the invention where a renderer ID is embedded when rendering a representation;

FIG. 3 shows a second embodiment of the invention where a source signature and a renderer ID are embedded in a rendered realization; and

FIG. 4 shows a third embodiment of the invention where a renderer ID is embedded in the output of a TTS system that uses recorded snippets of human speech to generate a rendered realization.

### DETAILED DESCRIPTION OF THE EMBODIMENTS

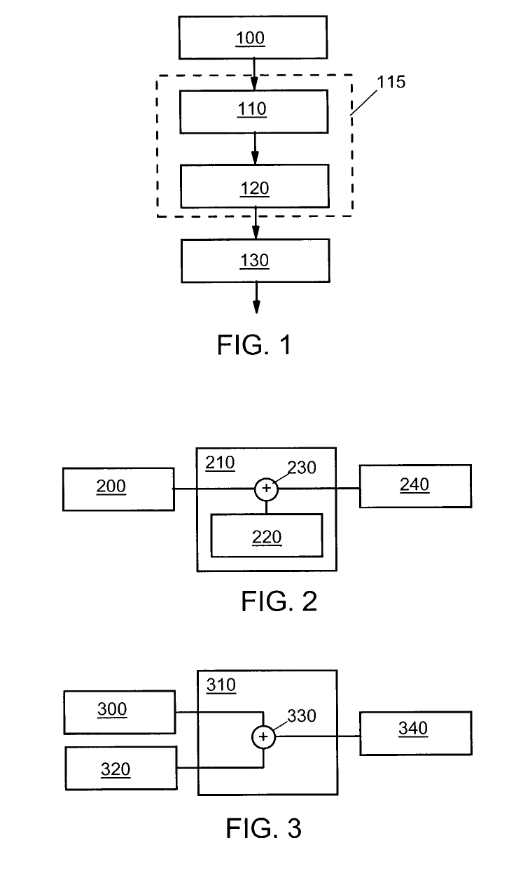

FIG. 1 is only for illustrating the basic principles of the present invention by way of a schematic block diagram. A representation 100, represented by a continuous symbolic data stream like a digitized text or compressed MPEG-2 or -4 file, is first input to a renderer 110 where the representation 100 is rendered. The rendered symbolic data stream is then input to a watermark generator 120 the signature is hidden in the rendered symbolic data stream. Any steganographic technique can be used to embed the signature in the generated realization. State-of-the-art steganographic techniques, like e.g. the ones described in Katzenbeisser/Petitcolas (Stefan Katzenbeisser/Fabien A. P. Petitcolas (eds.), Information Hiding, Artech Hause Boston 2000) and the literature cited therein, ensure that a realization containing a signature and a realization without signature are virtually indistinguishable for a human observer.

The watermark generator 120 preferably uses steganography as described in Japanese Patent Application 10164349 A and Ryuki Tachibana, Shuichi Shimizu, Seiji Kobayashi, and Taiga Nakamura, “An audio watermarking method robust against time- and frequency-fluctuation”, in Proc. of Security and Watermarking of Multimedia Contents III, SPIE vol. 4314, 2001.

It should be noted that the depicted separation between 110 and 120 is for illustrative purposes only. In most if not all embodiments of this invention the watermark generator 120 is integrated with the renderer 110 in functional unit 115 (see also third embodiment below).

The signature in the generated digital realization can be used to identify the individual renderer used or the source of the rendered data, or both. More particularly, in the case of a software renderer, it can consist of name of the executable and/or its serial number.

In case of a hardware renderer like an MPEG, CD or DVD player, a text-to-speech TTS system, or the like, the signature can be given by the type code and/or the serial number of the renderer particularly stored in read-only registers in the renderer's hardware.

As a result, a continuous digital realization of the symbolic audio stream, e.g. a piece of speech or music, is obtained that contains the hidden signature identifying the renderer and/or the representation used to generate the realization.

FIG. 2 shows a block diagram which depicts a watermarking renderer that embeds its own serial number (renderer ID) in the generated output signal, as mentioned above. In this embodiment, a representation 200 is input to a renderer 210. The renderer 210 then uses its renderer ID 220 and embeds the catched ID by using steganographic techniques 230. As result a rendered realization 240 is obtained.

A preferred steganographic method which can be used here is the algorithm by Tachibana et al. cited above.

FIG. 3 shows a block diagram similar to FIG. 2 for illustrating a watermarking renderer that embeds an additionally supplied signature in the generated output signal. In this embodiment, a representation 300 again is input to a renderer 310 together with a source signature 320 identifying the representation 300 to be rendered. The source signature 320 is embedded in the representation 300 by way of steganographic techniques 330. Accordingly, a preferred steganographic method is the algorithm by Tachibana et al. cited above.

The source signature 320 characterizes the symbolic representation used to render a realization 340. Only exemplarily, the source signature 320 can be the file name of the symbolic representation 300, a copyright notice identifying the copyright holder of the symbolic representation 300, or the identity of the institution that used the renderer 310 to generate the realization 340. In cases where the source signature is embedded in the realization (e.g. with techniques described in International Patent WO 00/45545), the signature is separated from the representation by appropriate methods (as e.g. described in International Patent WO 00/45545) and thereafter treated similar to a signature supplied by external means.

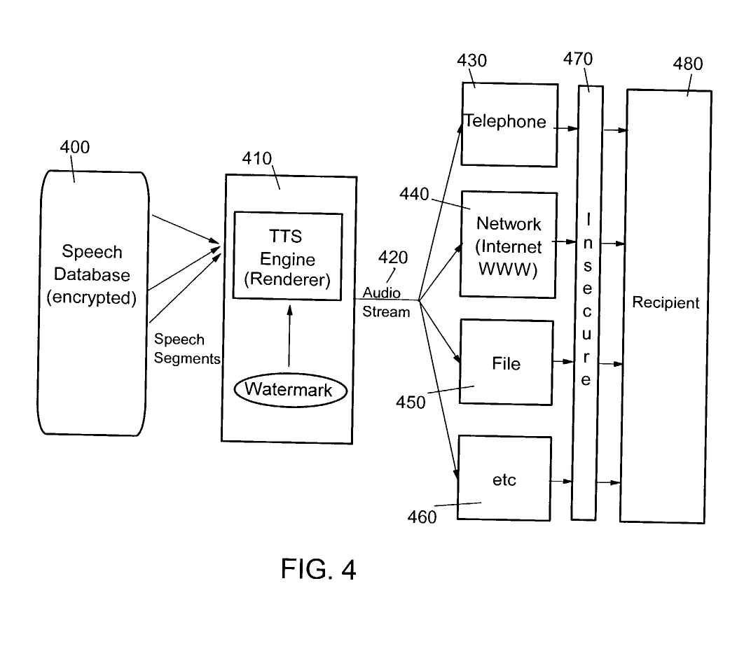

FIG. 4 is another block diagram illustrating the application of the invention in the case of a speech-sample based TTS system. Such text-to-speech systems use a speech database 400 of encrypted and compressed speech samples based on recordings of human speech. Most if not all of the samples in the database 400 are short sound samples. Due to their shortness, such samples either offer not enough space for a meaningful watermark or can not be marked at all by steganographic techniques.

A TTS Engine or renderer 410 selects speech segments based on the text to synthesize, decrypts and decompresses the speech segments and concatenates them. Then it adds a watermark. A preferred steganographic method is the algorithm by Tachibana et al. cited above. The watermark may contain e.g. a license number of the TTS engine 410 and a copyright info of the human speaker who provided the samples for the database. Proprietary encryption and compression formats for the speech samples may be used to preclude any attempt to replace the proprietary renderer by another one that does not write watermarks into the generated audio stream 420.

The audio stream 420 is a realization of textual input generated by the renderer containing also the watermark and may be in any of the formats suitable for audio data, e.g. wave, au, PCM, etc. This audio stream 420 can be fed e.g. into a telephony channel 430, a network (LAN, WAN, wireless, etc.) 440, a file 450, or etc. 460.

Whenever the audio stream 420 leaves the trusted environment of the TTS system, it may be transported over insecure connections 470 to a recipient 480. As a consequence of insecure connections, a recipient cannot be sure

if he gets the data from the source he expects and

whether the data has been manipulated during the transmission.

By checking for the integrity of a well-known watermark, the correct origin of the message can be proven by the recipient and a message without such a identification can be challenged or even refused.

Further it should be noted that this mechanism allows the speaker providing the speech samples to check which content has been generated using his speech samples. Most professional speakers have an interest of knowing what will be synthesized with his voice and may define this in a contract (e.g. business use but no extreme or immoral contents).

In addition the author of the renderer may use this mechanism to identify the license number of the TTS engine that produced a specific speech sample and check if the provider is within the license contract. This is especially important in cases where the TTS system has been used to generate audio material that is stored in e.g. a file or on a compact disc that is marketed and sold as an original and not as a derived product.

1. A method for rendering a digital representation into a digital realization, comprising the steps of:
receiving said digital representation as a symbolic data stream;
generating said digital realization and embedding authenticity information.

2. Method according to claim 1, further comprising embedding in said symbolic data stream an identification element using a watermark generator.

3. Method according to claim 2, wherein said identification element comprises a signature that identifies at least one of i) the individual renderer used, and ii) the source of the rendered data stream.

4. Method according to claim 3, wherein said signature is given by at least one of i) the name of the executable, and ii) the serial number of the renderer.

5. Method according to claim 2, wherein said identification element comprises a signature that characterizes the symbolic data stream of the representation used to render the realization.

6. Method according to claim 5, wherein said signature is at least one of i) the file name of the symbolic representation, ii) a copyright notice identifying the copyright holder of the symbolic representation, and iii) the identity of the institution that used the renderer to generate the signal.

7. Method according to claim 2, wherein said identification element is stored in an encrypted form.

8. Method according to claim 2, wherein said watermark generator is using steganography.

9. A computer program product stored on a computer usable medium, comprising computer readable program means for rendering a digital representation into a digital realization, comprising:
program means for receiving said digital representation as a symbolic data stream;
program means for generating said digital realization and embedding authenticity information.

10. An apparatus to render a digital representation into a digital realization, said apparatus comprising:
a renderer for rendering the digital representation into the digital realization;
a watermark generator for generating a signature;
means for embedding said generated signature or watermark in the rendered realization.

11. Apparatus according to claim 10, where said signature is given by at least one of i) the type code, and ii) the serial number of the renderer.

12. Apparatus according to claim 11, where said signature is stored in at least one read-only register of the renderer.
